(19) United States
(12) Patent Application Publication
(10) Pub. No.: US 2016/0237718 A1
(43) Pub. Date: Aug. 18, 2016

(54) A LOCK SYSTEM

(71) Applicant: TURKCELL ILETISIM HIZMETLERI ANONIM SIRKETI, Tepebasi, Istanbul (TR)

(72) Inventor: GOKHAN VARDAR, Istanbul (TR)

(73) Assignee: TURKCELL ILETISIM HIZMETLERI ANONIM SIRKETI, Istanbul (TR)

(21) Appl. No.: 15/027,081

(22) PCT Filed: May 13, 2015
(86) PCT No.: PCT/TR2015/000201

§ 371 Date: Apr. 4, 2016

(30) Foreign Application Priority Data
May 13, 2014 (TR) 2014/05348

(51) Int. Cl. E05B 47/00; E05C 1/02

(52) U.S. Cl. CPC E05B 47/0009; E05C 1/02

(57) ABSTRACT

The present invention relates to a lock system which enables to unlock upon the lock mechanism is separated when the lock cannot be opened as a result, of any problem in a lock mechanism, and essentially comprises: a shaft which carries out the locking process; a conductor which is located inside a recess that is opened on the surface of the shaft; an insulation material which provides the insulation between the shall and the conductor; an action mechanism which enables action of the shaft, comprises a receiver; a lock input-output housing wherein the shaft enters and enables the locking process: an upper section of lock input-output housing which has the lock input-output housing on thereof; a lower section of lock input-output housing which enables the upper section of lock input-output housing to be mounted; at least one connecting member which loses its form at high temperature; at least one resistance block which can reach high temperatures when current is passed over thereof; at least one flexible piece which enables the electrical connection between the conductor and the resistance block.

### TECHNICAL FIELD

The present invention relates to an electrical lock system which enables to unlock in case of failure.

### BACKGROUND OF THE INVENTION

Electrical lock systems are used in many structures commonly. Although there are systems which switch on-off themselves by taking advantage of basics such as an engine, a magnet, etc. upon taking command from electronic circuits in the state of the art; none of the mechanisms stated in these systems has a mechanism that can switch on itself in case of a failure. There are only lock systems which are made by means of a by-pass method and left in external and accessible environments. Due to the fact that the lock mechanism can be unlocked by persons knowing the situation in these by-pass methods, security is weakened.

When the user switches off the lock systems in the inner space by means of electronic circuit, s/he may face a situation that the lock mechanisms do not switch on when s/he wants to get in from outside by means of these methods again. In this case, it may be obliged to intervene the door and the lock physically or necessity will arise to activate the by-pass systems as mentioned. Both cases impose an undesired burden for users and also a weakness for the system. Therefore, the benefit desired cannot be provided.

### SUMMARY OF THE INVENTION

The present invention relates to a lock system which can provide communication over all wired and wireless networks or make decision notwithstanding the communication. When the lock takes command over the electronic circuit, it performs its locking function by moving linearly and entering the corresponding lock housing system. In the event that a mechanical problem is confronted while in the locked state, it can switch on the connections of the lock by the command taken.

### DETAILED DESCRIPTION OF THE INVENTION

“A lock system” realized to fulfill the objectives of the present invention is shown in the figures attached, in which:

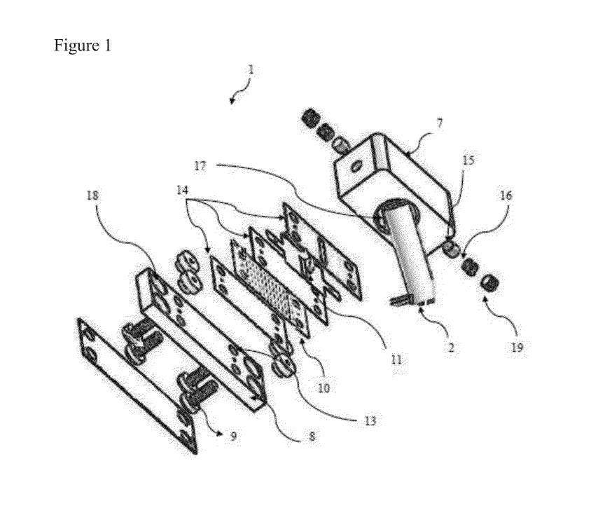

FIG. 1 is an exploded view of the lock system.

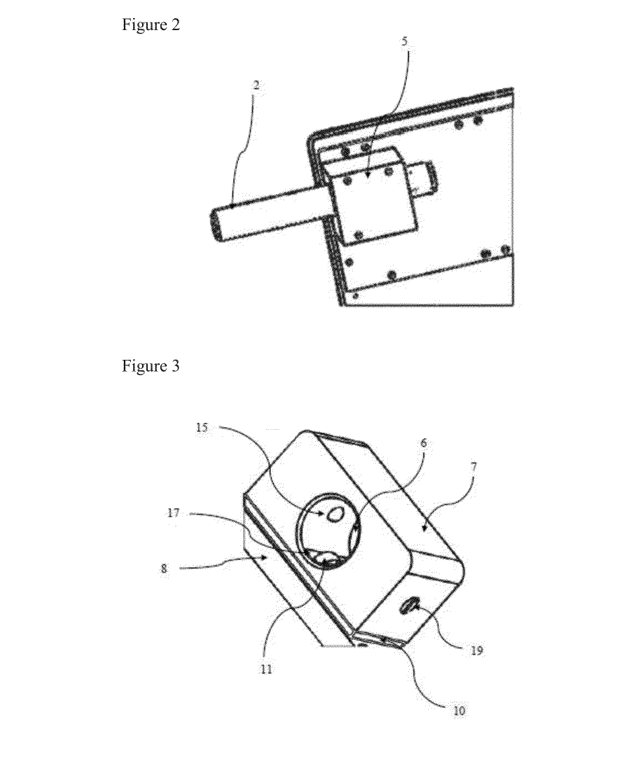

FIG. 2 is a view of the main body of the lock.

FIG. 3 is an upper view of the lock input-output housing.

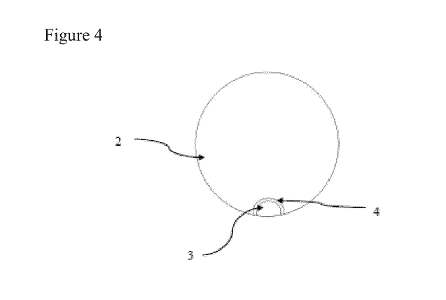

FIG. 4 is a front view of the shaft.

The components illustrated in the figures are individually numbered, where the numbers refer to the following:
1. Lock system
2. Shaft
3. Conductor
4. Insulation material
5. Action mechanism
6. Lock input-output housing
7. Upper section of lock input-output housing
8. Lower section of lock input-output housing
9. Connecting member
10. Resistance block
11. Flexible piece
12. Mounting apparatus
13. Hole
14. Insulating plate
15. Conductive ball
16. Spring
17. Aperture
18. Mounting hole
19. Screw

The inventive lock system (1) enabling to switch on a defective locking mechanism essentially comprises:
at least one shaft (2) which carries out the locking process, is movable and has electrical conductivity;
at least one conductor (3) which is located inside a recess that is preferably opened on the surface of the shaft (2), enables to transmit the electric current;
at least one insulation material (4) which provides the insulation between the shaft (2) and the conductor (3);
at least one action mechanism (5) which enables the action of the shaft (2) and controls the passage of current over the shaft (2), can take command over a receiver in a wired or wireless way;
at least one lock input-output housing (6) wherein the shaft (2) enters upon being moved by the action mechanism (5) and enables the locking process;
at least one upper section of lock input-output housing (7) which has the lock input-output housing (6) on thereof, is made of a conductive material;
at least one lower section of lock input-output housing (8) which enables the upper section of lock input-output housing (7) to be mounted to a desired place;
at least one connecting member (9) which connects the upper section of lock input-output housing (7) and the lower section of lock input-output housing (8) and loses its form at high temperature;
at least one resistance block (10) which is located between the upper section of lock input-output housing (7) and the lower section of lock input-output housing (8), through which the connecting members (9) passes, and which can reach high temperatures when current is passed over thereof;
at least one flexible piece (11) which enables the electrical connection between the conductor (3) and the resistance block (10), and has electrical conductivity;
at least one aperture (17) through which the flexible piece (11) passes and extends in the form of a protrusion, and which is located in the lower part of the upper section of lock input-output housing (7).

The inventive lock system (1) has a shaft (2) with a movable and conductive characteristic which carries out the locking process. The shaft (2)—which is preferably in the form of cylinder—has a conductor (3) that is located inside a recess opened on the outer surface thereof and enables transmission of electric current, extends along thereof A conducting strip can be used for this conductor (3) as well. An insulation material (4) providing electrical insulation is placed between the conductor (3) and the shaft (2).

The shaft (2) can move bidirectionally in the horizontal plane by means of the action mechanism (5). The action mechanism (5) has a receiver which can take command n a wired or wireless way, control the action. By commands to be issued to this receiver, the shaft (2) can carry out the processes of locking and unlocking by moving forwards-backwards in horizontal plane. The said receiver can also control current transition over the shaft (2) and the conductor (3), it can act as a switch.

the inventive lock system (1), the shaft (2) is moved horizontally together with the action mechanism (5) so as to carry out the locking process. The locking process is realized upon the end portion of the shaft (2) in the direction of movement enters the lock input-output housing (6) corresponding to the end portion in the direction of movement where the shaft (2) moves. The lock input-output housing (6) is located on the upper section of lock input-output housing (7) which is made of a conductive material.

By means of the mounting holes (18) located on thereof, the lower section of lock input-output housing (8) can be inserted to the place where the inventive lock system (1) will be fitted upon being mounted. In another embodiment of the invention, it is possible to fix the lower section of lock input-output housing (8) to a desired place by means of a is mounting apparatus (12). The lower section of lock input-output housing (8) has holes (13) which can melt by heat, and where the connecting members (9) preferably in the form of screw and made of delrin plastic can be placed. Although the connecting member (9) has high strength at normal temperatures, it has the characteristic of breaking by melting at high temperatures. The connecting member (9) extends until the upper section of lock input-output housing (7) by passing through the holes (13) of the lower section of lock input-output housing (8). Thus, the lower section of lock input-output housing (8) and the upper section of lock input-output housing (7) are combined,

There is a resistance block (10) which surrounds the connecting members (9) between the lower section of lock input-output housing (8) and the upper section of lock input-output housing (7) combined by means of the connecting members (9). The resistance block (10) can reach high temperatures upon getting warmer when current passes through the terminal ends of the resistance block (10).

Between the resistance block (10) and the upper section of lock input-output housing (7), there is a flexible piece (11) which enables the electrical connection between the conductor (3) and the resistance block (10). The flexible piece (11) with conductive characteristic, which extends from the aperture (17) on the lower part of the upper section of lock input-output housing (7) to the lock input-output housing (6) in the form of a protrusion, establishes the electrical connection between a terminal end of the resistance block (10) and the conductor (3) by contacting the conductor (3).

For the purpose of providing electricity and heat insulation, insulating plates (14) can be preferably used between the upper section of lock input-output housing (7) and the flexible piece (11), between the flexible piece (11) and the resistance block (10), and between the resistance block (10) and the lower section of lock input-output housing (8).

The present invention enables to unlock upon the lock mechanism is separated when the lock cannot be opened as a result of an undesired entrapment in the lock mechanism or any problem in the lock system (1). Therefore, a signal is sent to the receiver by the user. This signal can be a signal that can be protected by password. In another embodiment of the invention, processes desired can be carried out by entering password by means of a keypad located on the lock system (1). There is any power source connected to the ends of the shaft (2) and the conductor (3). One terminal of the power source is connected to the shaft (2) and the other pole thereof is connected to the conductive section. After the receiver takes the signal, it completes the circuit between the shaft (2) and the conductor (3) and then creates a potential difference between these two pieces.

By means of the conductive balls (15) located in the lock input-output housing (6), the shaft (2) is in contact with the upper section of lock input-output housing (7) and electrical conduction is provided between thereof. The conductive balls (15) ensure that the contact between the shaft (2) and the conductive balls (15) is provided tightly upon being pushed towards the lock input-output housing (6) by means of the springs (16). Preferably, screws (1) which can be inserted from lateral sections of the upper section of lock input-output housing (7) can be used in order to reach the conductive balls (15) and the springs (16) more easily and provide mounting convenience. Electrical connection is established over the upper section of lock input-output housing (7) to a terminal end of the resistance block (10) having physical connection with the upper section of lock input-output housing (7) directly. The other end of the resistance block (10) is connected to the conductive flexible piece (11). The conductive flexible piece (11) is in connection with the conductor (3), which is connected to the other pole of the power sources, and the circuit is completed.

Upon the circuit is completed, the resistance block (10) gets heated after current passes through the resistance block (10). The resistance block (10) heated enables to separate the upper section of lock input-output housing (7) and the lower section of lock input-output housing (8) by melting the connecting members (9) and allows unlocking.

In another embodiment of the invention, an alternative connecting member (9) which combines the upper section of lock input-output housing (7) and the lower section of lock input-output housing (8), loses its form when current passes over it is used without needing the resistance block (10). It can be ensured to separate the upper section of lock input-output housing (7) and the lower section of lock input-output housing (8) by passing current over the alternative connecting member (9) directly.

In another embodiment of the invention, instead of providing the electricity current over the upper section of lock input-output housing (7) directly, the potential difference on the shaft (2) is transmitted to a terminal end of the resistance block (10) by means of a cable passing through a channel opened inside the upper section of lock input-output housing (7). In addition to this, the upper section of lock input-output housing (7) can be preferably coated with a conductive material in order to ensure electrical insulation.

1. A lock system (1) which enables to unlock upon the lock mechanism is separated when the lock cannot be opened as a result of an undesired entrapment in the lock mechanism or any problem in the lock mechanism and is essentially characterized by:
at least one shaft (2) which carries out the locking process, is movable and has electrical conductivity;
at least one conductor (3) which is located inside a recess that is preferably opened on the surface of the shaft (2), enables to transmit the electric current;
at least one insulation material (4) which provides the insulation between the shaft (2) and the conductor (3);
at least one action mechanism (5) which enables the action of the shaft (2) and controls the passage of current over the shaft (2), can take command over a receiver in a wired or wireless way;
at leant one lock input-output housing (6) wherein the shaft (2) enters upon being moved by the action mechanism (5 and enables the locking process;
at least one upper section of lock input-output housing (7) which has the lock input-output housing (6) on thereof, is made of a conductive material;
at least one lower section of lock input-output housing (8) which enables the upper section of lock input-output housing (7) to be mounted to a desired place;
at least one connecting member (9) which connects the upper section of lock input-output housing (7) and the lower section of lock input-output housing (8) and loses its form at high temperature;
at least one resistance block (10) which is located between the upper section of lock input-output housing (7) and the lower section of lock input-output housing (8), through which the connecting members (9) passes, and which cart reach high temperatures when current is passed over thereof;
at least one flexible piece (11) which enables the electrical connection between the conductor (3) and the resistance block (10), and has electrical conductivity;
at least one aperture (17) through which the flexible piece (11) passes and extends in the form of a protrusion, and which is located in the lower part of the upper section of lock input-output housing (7).

2. A lock system (1) according to claim 1, characterized by at least one conductor (3) which is located on the lower part of the shaft (2)—that is preferably in the form of cylinder—and allows transmission of electric current, can be in the form of a strip extending along the cylindrical, shaft (2).

3. A lock system (1) according to claim 1, characterized by at least one mounting hole (18) which is located on the lower section of lock input-output housing (8), enables the lock to be mounted to the place where it will be fitted.

4. A lock system (1) according to claim characterized by at least one mounting apparatus (12) which enables the lower section of lock input-output housing (8) to be mounted to desired place.

5. A lock system (1) according to claim 1, characterized by the connecting member (9) which connects the upper section of lock input-output housing (7) and the lower section of lock input-output housing (8), loses its form when current passes over thereof.

6. A to system (1) according to claim 1, characterized by at least one hole (13) which is located in the lower section of lock input-output housing (8), enables to place the connecting members (2) that an melt by temperature.

7. A lock system (1) according to claim 1, characterized by at least one conductive ball (15) which is located hi the lock input-output housing (6), enables electrical conduction between the shaft (2) and the upper section at lock input-output housing (7).

8. A lock system (1) according to claim 1, characterized by at least one spring (16) which enables to provide the contact between the shaft (2) and the conductive balls (15) tightly upon being pushed towards the lock input-output housing (6).
